(19) United States
(12) Patent Application Publication
(10) Pub. No.: US 2024/0014414 A1
(43) Pub. Date: Jan. 11, 2024

(54) FUEL CELL SYSTEM

(71) Applicants: HYUNDAI MOTOR COMPANY, Seoul (KR); KIA CORPORATION, Seoul (KR)

(72) Inventors: Jin Young Park, Incheon (KR); Hee Sung Yoon, Seoul (KR); Sang Hoon Ahn, Yongin-si (KR); Nam Woo Lee, Hwaseong-si (KR); Tae Woo Kim, Yongin-si (KR)

(73) Assignees: HYUNDAI MOTOR COMPANY, Seoul (KR); KIA CORPORATION, Seoul (KR)

(21) Appl. No.: 18/080,231

(22) Filed: Dec. 13, 2022

(30) Foreign Application Priority Data
Jul. 8, 2022 (KR) 10-2022-0084537

(51) Int. Cl. H01M 8/04014; H01M 8/04089; H01M 8/22; H01M 8/2465

(52) U.S. Cl. CPC H01M 8/04014; H01M 8/04089; H01M 8/222; H01M 8/2465

(57) ABSTRACT

A fuel cell system includes: an oxygen concentration module to produce oxygen-enriched air by separating nitrogen from air, and a first air supply line connected to the oxygen concentration module to supply air to the oxygen concentration module. The fuel cell system further includes: a heating unit provided in the first air supply line to selectively heat air by using waste heat discharged from an external heat source provided outside a fuel cell stack, a second air supply line connected to the oxygen concentration module and configured to supply air to the oxygen concentration module independently of the first air supply line, a cooling unit provided in the second air supply line and configured to selectively cool air by using outside cold energy, and a stack connection line which connects the oxygen concentration module and the fuel cell stack and supplies the oxygen-enriched air to the fuel cell stack.

### CROSS-REFERENCE TO RELATED APPLICATION

This application claims priority to and the benefit of Korean Patent Application No. 10-2022-0084537 filed in the Korean Intellectual Property Office on Jul. 8, 2022, the entire contents of which are incorporated herein by reference.

### TECHNICAL FIELD

The present disclosure relates to a fuel cell system, and more particularly, to a fuel cell system capable of improving an output and system efficiency.

### BACKGROUND

The statements in this section merely provide background information related to the present disclosure and may not constitute prior art.

A fuel cell system refers to a system that produces electrical energy by means of a chemical reaction of fuel. Research and development are consistently performed on the fuel cell system as an alternative capable of solving global environmental issues.

In general, the fuel cell electric system may include a fuel cell stack configured to generate electricity by means of an oxidation-reduction reaction between hydrogen and oxygen (O₂). The fuel cell electric system may also include a fuel supply device configured to supply fuel (hydrogen) to the fuel cell stack, and an air supply device (air processing system) configured to supply the fuel cell stack with air (oxygen) which includes an oxidant required for an electrochemical reaction.

Recently, various attempts have been made to apply the fuel cell system to various mobilities such as ships as well as passenger vehicles (or commercial vehicles).

Meanwhile, to improve efficiency and output of the fuel cell system, it is desired to increase concentration (purity) of oxygen as well as concentration of hydrogen to be supplied to the fuel cell stack.

In the related art, a method has been proposed, which improves oxygen purity of air to be supplied to the fuel cell stack. Such a method allows an adsorbent to adsorb nitrogen contained in air through a pressure swing adsorption process or a temperature swing adsorption process.

However, in the case of the pressure swing adsorption process based on a change in pressure, there is a problem in that it is difficult to increase a rate of adsorbing nitrogen to a certain level or higher. In the case of the temperature swing adsorption process based on a change in temperature, there is a problem in that a large amount of time is required to raise or lower a temperature, which makes it difficult to sufficiently ensure the amount of treatment per unit time (the amount of concentration and treatment on oxygen).

Therefore, in the related art, a method has been proposed, which improves oxygen purity of air to be supplied to the fuel cell stack by allowing the adsorbent to adsorb nitrogen contained in air through the pressure-temperature swing adsorption process that simultaneously implements a change in pressure and a change in temperature.

However, in the related art, the pressure-temperature swing adsorption process (e.g., a step of raising a temperature and a step of lowering a temperature) excessively consumes energy to concentrate (enrich) oxygen in air, which makes it difficult to improve efficiency of the fuel cell system (energy efficiency).

In other words, in the related art, high-purity oxygen (oxygen-enriched air) is used, which makes it possible to improve an output of the fuel cell system. However, because a process (pressure-temperature swing adsorption process) of concentrating oxygen consumes a large amount of energy, it is difficult to improve overall efficiency of the fuel cell system (energy efficiency).

Therefore, recently, various studies have been conducted to minimize the energy consumption required for the process of concentrating oxygen and improve the output of the fuel cell system and the system efficiency, but the study results are still insufficient.

### SUMMARY

The present disclosure provides a fuel cell system capable of improving an output and system efficiency.

The present disclosure reduces or minimizes consumption of energy (parasitic electric power) required for a process of concentrating oxygen and improves an output and efficiency of a fuel cell system.

Among other things, the present disclosure performs a pressure-temperature swing adsorption process of improving purity of oxygen by using cold energy of seawater and waste heat (exhaust gas) generated by an engine of a ship.

In addition, the present disclosure increases the amount of oxygen to be treated and efficiency in concentrating oxygen and minimizes the amount of time required for a process of concentrating oxygen.

The present disclosure also reduces or minimizes deterioration in performance caused by degradation of a fuel cell stack.

The objects to be achieved by the embodiments are not limited to the above-mentioned objects, but also include objects or effects that may be understood from the solutions or embodiments described below.

In an embodiment of the present disclosure, a fuel cell system includes: an oxygen concentration module configured to produce oxygen-enriched air by separating nitrogen from air; and a first air supply line connected to the oxygen concentration module and configured to supply air to the oxygen concentration module. The fuel cell system further includes a heating unit provided in the first air supply line and configured to selectively heat air, which is supplied through the first air supply line, by using waste heat discharged from an external heat source provided outside a fuel cell stack. The fuel cell system further includes a second air supply line connected to the oxygen concentration module and configured to supply air to the oxygen concentration module independently of the first air supply line. The fuel cell system further includes: a cooling unit provided in the second air supply line and configured to selectively cool air, which is supplied through the second air supply line, by using outside cold energy applied from the outside of the fuel cell stack; and a stack connection line configured to connect the oxygen concentration module and the fuel cell stack and to supply the oxygen-enriched air to the fuel cell stack.

The present disclosure improves the output and system efficiency of the fuel cell system.

In the related art, high-purity oxygen (oxygen-enriched air) is used, which makes it possible to improve an output of the fuel cell system. However, because a process (pressure-temperature swing adsorption process) of concentrating oxygen consumes a large amount of energy, it is difficult to improve overall efficiency of the fuel cell system (energy efficiency).

However, in embodiments of the present disclosure, the waste heat (high-temperature exhaust gas) discharged from the object (e.g., the engine of the ship) and the cold energy of the seawater are used as energy source the oxygen concentration module that performs the oxygen concentration process (e.g., the pressure-temperature swing adsorption process).

In addition, according to the embodiments of the present disclosure, it is not necessary to separately provide heat and cooling sources for the pressure-temperature swing adsorption process of the oxygen concentration module. Therefore, it is possible to obtain an advantageous effect of simplifying the structure and improving the spatial utilization and the degree of design freedom.

According to another embodiment of the present disclosure, the oxygen concentration module may include a plurality of oxygen concentrators that independently and respectively accommodates the adsorbents for selectively adsorbing and desorbing nitrogen based on a temperature and pressure of air. The plurality of oxygen concentrators may be connected in parallel to the first and second air supply lines.

The number of oxygen concentrators constituting the oxygen concentration module may be variously changed in accordance with required conditions and design specifications.

For example, the oxygen concentration module may include: a first oxygen concentrator configured to selectively produce oxygen-enriched air; and a second oxygen concentrator connected in parallel to the first oxygen concentrator and configured to selectively generate the oxygen-enriched air independently of the first oxygen concentrator.

According to one embodiment of the present disclosure, the first and second oxygen concentrators may alternately produce the oxygen-enriched air. The stack connection line may continuously supply the oxygen-enriched air to the fuel cell stack.

For reference, in the embodiments of the present disclosure, the external heat sources disposed outside the fuel cell stack may be understood as including all various external heat sources positioned outside the fuel cell stack and provided in an object in which the fuel cell stack is mounted.

According to an embodiment of the present disclosure, the external heat source may include at least one of an engine or a battery provided in an object (e.g., a vehicle) in which the fuel cell stack is mounted.

The heating unit may have various structures capable of heating the air supplied through the first air supply line by using waste heat discharged from the engine.

According to another embodiment of the present disclosure, the heating unit may include: an exhaust gas guide line configured to guide exhaust gas discharged from the engine; and a first heat exchanger configured to allow the exhaust gas to exchange heat with the air supplied through the first air supply line.

As described above, according to the embodiments of the present disclosure, the exhaust gas and the air supplied through the first air supply line exchange heat with each other. Therefore, it is possible to obtain an advantageous effect of reducing or minimizing the consumption of electric power required to heat the air supplied through the first air supply line (e.g., minimizing an operation of a heater) and improving energy efficiency.

In addition, in the embodiments of the present disclosure, the outside cold energy applied from the outside of the fuel cell stack may be understood as including all various types of outside cold energy capable of being applied from the outside of the fuel cell stack.

According to one embodiment of the present disclosure, the outside cold energy may include at least one of cold energy of seawater or cold energy of the atmospheric air (low-temperature air in the atmosphere).

The cooling unit may have various structures capable of cooling the air supplied through the second air supply line by using cold energy of seawater.

According to an embodiment of the present disclosure, the cooling unit may include: a seawater supply line configured to supply seawater; and a second heat exchanger configured to allow the seawater to exchange heat with the air supplied through the second air supply line.

As described above, according to the embodiments of the present disclosure, the air supplied through the second air supply line and the seawater exchange heat with each other. Therefore, it is possible to obtain an advantageous effect of reducing or minimizing the consumption of electric power required to cool the air supplied through the second air supply line (e.g., minimizing an operation of a heat pump) and improving energy efficiency.

According to an embodiment of the present disclosure, the air to be supplied to the oxygen concentration module through the first air supply line is defined as having a first pressure and a first temperature, and the air to be supplied to the oxygen concentration module through the second air supply line is defined as having a second pressure higher than the first pressure and having a second temperature lower than the first temperature.

According to an embodiment of the present disclosure, the fuel cell system may include a buffer tank provided in the stack connection line and configured to temporarily store the oxygen-enriched air.

Because the buffer tank is provided in the stack connection line as described above, it is possible to obtain an advantageous effect of reducing or minimizing changes in supply pressure and flow rate of the oxygen-enriched air caused by pulsation or hunting. Further, it is possible to obtain an advantageous effect of constantly maintaining the supply pressure and flow rate of the oxygen-enriched air to be supplied to the fuel cell stack.

According to an embodiment of the present disclosure, the fuel cell system may include a flow rate adjusting unit provided in the stack connection line and configured to adjust a supply flow rate of the oxygen-enriched air.

Because the flow rate adjusting unit is provided in the stack connection line as described above, it is possible to obtain an advantageous effect of optimizing the supply flow rate of the oxygen-enriched air to be supplied to the fuel cell stack in accordance with the operating condition of the fuel cell stack.

The connection structure between the oxygen concentration module and the first and second air supply lines may be variously changed in accordance with required conditions and design specifications.

According to other embodiment of the present disclosure, the fuel cell system includes: a first-first connection line configured to connect the first air supply line and the first oxygen concentrator and connected to the stack connection line; and a first-second connection line configured to connect the first air supply line and the second oxygen concentrator and connected to the stack connection line. The fuel cell system further includes: a second-first connection line configured to connect the second air supply line and the first oxygen concentrator; and a second-second connection line configured to connect the second air supply line and the second oxygen concentrator. The fuel cell system further includes: a first exhaust line connected to the second-first connection line; a second exhaust line connected to the second-second connection line; and a first valve configured to selectively open or close the first-first connection line and connected to the stack connection line. The fuel cell system further includes: a second valve configured to selectively open or close the first-second connection line and connected to the stack connection line; a third valve configured to selectively open or close the second-first connection line and connected to the first exhaust line; and a fourth valve configured to selectively open or close the second-second connection line and connected to the second exhaust line.

According to another embodiment of the present disclosure, the fuel cell system may include: an exhaust connection line connected to the first air supply line and configured to connect the first exhaust line and the second exhaust line in parallel; and an exhaust valve configured to selectively open or close the exhaust connection line.

Because the nitrogen air discharged through the first and second exhaust lines is discharged through the exhaust connection line as described above, it is possible to obtain an advantageous effect of minimizing the structures and sizes of the first and second exhaust lines and improving the spatial utilization and the degree of design freedom.

In addition, when the exhaust connection line is connected to the first air supply line, the air supplied through the first air supply line may be discharged directly to the outside through the exhaust connection line without passing through the oxygen concentration module (e.g., the first oxygen concentrator and the second oxygen concentrator).

According to one embodiment of the present disclosure, the fuel cell system may include: a bypass line configured to connect the second air supply line and the stack connection line and to allow the air to flow from the second air supply line to the stack connection line, and a bypass valve configured to selectively of the bypass line.

As described above, in the embodiment of the present disclosure, the bypass line configured to connect the second air supply line and the stack connection line is provided. Therefore, when a target oxygen concentration of the oxygen-enriched air produced by the oxygen concentration module is lower than an atmospheric oxygen concentration (an oxygen concentration of air in the atmosphere), the air supplied through the second air supply line (the air having a sufficient oxygen concentration) may flow directly to the stack connection line without passing through the oxygen concentration module.

### BRIEF DESCRIPTION OF THE DRAWINGS

In order that the disclosure may be well understood, there will now be described various forms thereof, given by way of example, reference being made to the accompanying drawings, in which:

FIG. 1 is a view illustrating a fuel cell system according to one embodiment of the present disclosure;

FIG. 2 is a view illustrating an adsorption mode of a first oxygen concentrator of the fuel cell system according to one embodiment of the present disclosure;

FIG. 3 is a view illustrating a regeneration mode of the first oxygen concentrator of the fuel cell system according to one embodiment of the present disclosure;

FIG. 4 is a view illustrating a rest mode of the first oxygen concentrator of the fuel cell system according to one embodiment of the present disclosure;

FIG. 5 is a view illustrating a bypass line of the fuel cell system according to one embodiment of the present disclosure;

FIG. 6 is a flowchart for illustrating a method of controlling the fuel cell system according to one embodiment of the present disclosure; and

FIGS. 7 and 8 are views respectively illustrating a modified example of the fuel cell system according to one embodiment of the present disclosure.

The drawings described herein are for illustration purposes only and are not intended to limit the scope of the present disclosure in any way.

### DETAILED DESCRIPTION

Hereinafter, embodiments of the present disclosure are described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure. Thus, the following description is merely exemplary in nature and is not intended to limit the present disclosure, application, or uses. It should be understood that throughout the drawings, corresponding reference numerals indicate like or corresponding parts and features.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, or C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

When a component, device, element, or the like of the present disclosure is described as having a purpose or performing an operation, function, or the like, the component, device, or element should be considered herein as being “configured to” meet that purpose or to perform that operation or function.

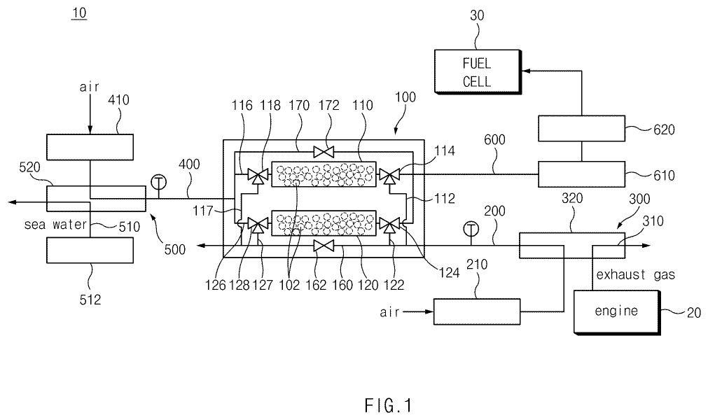

Referring to FIGS. 1 to 5, a fuel cell system 10 according to an embodiment of the present disclosure includes: an oxygen concentration module 100 configured to produce oxygen-enriched air by separating nitrogen from air through pressure temperature swing adsorption (pressure-temperature swing adsorption); and a first air supply line 200 connected to the oxygen concentration module 100 and configured to supply air to the oxygen concentration module 100, The fuel cell system 10 further includes: a heating unit 300 provided in the first air supply line 200 and configured to selectively heat air, which is supplied through the first air supply line 200, by using waste heat discharged from an external heat source provided outside a fuel cell stack 30; and a second air supply line 400 connected to the oxygen concentration module 100 and configured to supply air to the oxygen concentration module 100 independently of the first air supply line 200. In addition, the fuel cell system 10 further includes: a cooling unit 500 provided in the second air supply line 400 and configured to selectively cool air, which is supplied through the second air supply line 400, by using outside cold energy applied from the outside of the fuel cell stack 30; and a stack connection line 600 configured to connect the oxygen concentration module 100 and the fuel cell stack 30 and supply the oxygen-enriched air to the fuel cell stack 30.

For reference, the fuel cell system 10 according to the embodiment of the present disclosure may be applied to various vehicles, ships, mobility vehicles in aerospace fields, or the like to which the fuel cell stack 30 may be applied. The present disclosure is not restricted or limited by the types and properties of the target objects to which the fuel cell system is applied.

Hereinafter, as one embodiment of the present disclosure, the fuel cell system 10 applied to a ship is described below.

The fuel cell stack 30 refers to a kind of power generation device that generates electrical energy through a chemical reaction of fuel (e.g., hydrogen). The fuel cell stack may be configured by stacking several tens or hundreds of fuel cells (unit cells) (not illustrated) in series.

For example, the fuel cell may include a membrane electrode assembly (MEA) having an electrolyte membrane configured to allow hydrogen positive ions to move therethrough, and electrodes (catalyst electrode layers) provided on two opposite surfaces of the electrolyte membrane and configured to enable a reaction between hydrogen and oxygen. The fuel cell may also include gas diffusion layers (GDLs) disposed to be in close contact with two opposite surfaces of the membrane electrode assembly. The GDLs are configured to distribute reactant gases and transfer the generated electrical energy. The fuel cell may also include separators (bipolar plates) disposed to be in close contact with the gas diffusion layers and configured to define flow paths.

In the fuel cell stack 30, hydrogen is fuel, and air (inflow gas) is an oxidant. The hydrogen and air are supplied to an anode and a cathode of the membrane electrode assembly, respectively, through flow paths in the separators, such that the hydrogen is supplied to the anode, and the air is supplied to the cathode.

The hydrogen supplied to the anode is decomposed into hydrogen ions (protons) and electrons by catalysts in the electrode layers provided at two opposite sides of the electrolyte membrane. Only the hydrogen ions are selectively transmitted to the cathode through the electrolyte membrane, which is a cation exchange membrane, and at the same time, the electrons are transmitted to the cathode through the gas diffusion layer and the separator which are conductors.

At the cathode, the hydrogen ions supplied through the electrolyte membrane and the electrons transmitted through the separator meet oxygen in the air supplied to the cathode by an air supply device, thereby creating a reaction of producing water. As a result of the movement of the hydrogen ions, the electrons flow through external conductive wires, and the electric current is generated as a result of the flow of the electrons.

The oxygen concentration module 100 is configured to produce the oxygen-enriched air by separating nitrogen from air through the pressure temperature swing adsorption (pressure-temperature swing adsorption).

In this case, the oxygen-enriched air may be understood as air made by maximally removing nitrogen that accounts for the largest specific gravity in the air. The oxygen-enriched air may have a high-purity oxygen concentration.

The pressure-temperature swing adsorption process refers to a process of producing oxygen-enriched air by repeatedly performing a step of adsorbing impurities (nitrogen) to an adsorbent 102 by using a difference in affinity between components related to the adsorbent 102 (e.g., the nature of more strongly adsorbing nitrogen) and a step of regenerating the adsorbent 102 (desorbing nitrogen) again when the adsorption of nitrogen is saturated.

Various adsorbents 102 may be used as the adsorbent 102 used for the pressure-temperature swing adsorption process in accordance with required conditions and design specifications. The present disclosure is not restricted or limited by the type and properties of the adsorbent 102.

For example, zeolite, which is a microporous silicate mineral, may be used as the adsorbent 102. In this case, zeolite may be understood as including natural zeolite and synthetic zeolite.

For reference, the adsorbent 102 (e.g., zeolite) adsorbs nitrogen in air under a low-temperature high-pressure condition (adsorption mode) and desorbs (separates) the adsorbed nitrogen under a high-temperature low-pressure condition (regeneration mode). In particular, in the pressure-temperature swing adsorption process, adsorption and desorption performance of the adsorbent 102 may be maximized as a difference in temperature between the adsorption mode and the regeneration mode increases.

The oxygen concentration module 100 may have various structures capable of producing oxygen-enriched air by separating nitrogen from air through the pressure-temperature swing adsorption process using high-temperature low-pressure air and low-temperature high-pressure air. The present disclosure is not restricted or limited by the structure of the oxygen concentration module 100.

According to one embodiment of the present disclosure, the oxygen concentration module 100 may include a plurality of oxygen concentrators that independently and respectively accommodates the adsorbents 102 (e.g., zeolite) for selectively adsorbing and desorbing nitrogen based on a temperature and a pressure of air. The plurality of oxygen concentrators may be connected in parallel.

The number of oxygen concentrators constituting the oxygen concentration module 100 may be variously changed in accordance with required conditions and design specifications. The present disclosure is not restricted or limited by the number of oxygen concentrators and the arrangement structure of the oxygen concentrators.

In one embodiment, the oxygen concentration module 100 includes: a first oxygen concentrator 110 configured to selectively produce oxygen-enriched air; and a second oxygen concentrator 120 connected in parallel to the first oxygen concentrator 110 and configured to selectively produce oxygen-enriched air independently of the first oxygen concentrator 110.

The first oxygen concentrator 110 and the second oxygen concentrator 120 may have various structures capable of producing oxygen-enriched air by separating nitrogen from air.

In one embodiment, the first oxygen concentrator 110 and the second oxygen concentrator 120 may have the same structure and capacity. Alternatively, the first oxygen concentrator 110 and the second oxygen concentrator 120 may have different structures.

For example, the first and second oxygen concentrators 110 and 120 may each include a storage container (storage tank, not illustrated) having an accommodation space therein, and the adsorbents 102 (e.g., zeolite) accommodated in the storage container. For example, the storage container may be provided in a kind of cylindrical shape.

In the embodiments of the present disclosure illustrated and described above, the oxygen concentration module 100 includes the two oxygen concentrators is described. However, according to another embodiment of the present disclosure, the oxygen concentration module may include three or more oxygen concentrators. Alternatively, the oxygen concentration module may include only a single oxygen concentrator.

In another embodiment of the present disclosure, the plurality of oxygen concentrators constituting the oxygen concentration module 100 may be connected in parallel. However, according to other embodiment of the present disclosure, the plurality of oxygen concentrators constituting the oxygen concentration module may be configured to be independently separated (the plurality of oxygen concentrators may be respectively connected to the first and second air supply lines).

The operating modes of the plurality of oxygen concentrators may be determined to be identical to or different from one another in accordance with required conditions and design specifications.

According to one embodiment of the present disclosure, in a case in which some of the plurality of oxygen concentrators perform the adsorption mode adsorbing nitrogen to the adsorbents 102, the other oxygen concentrators may perform the regeneration mode for desorbing nitrogen from the adsorbents 102 or perform a rest mode for cutting off an inflow of air.

In particular, the first and second oxygen concentrators 110 and 120 may alternately produce the oxygen-enriched air. The stack connection line 600 may continuously supply the oxygen-enriched air to the fuel cell stack.

For example, the second oxygen concentrator 120 may perform the regeneration mode for desorbing nitrogen from the adsorbent 102 while the first oxygen concentrator 110 performs the adsorption mode for producing oxygen-enriched air. On the contrary, the first oxygen concentrator 110 may perform the regeneration mode for desorbing nitrogen from the adsorbent 102 while the second oxygen concentrator 120 performs the adsorption mode for producing oxygen-enriched air.

In the embodiment of the present disclosure illustrated and described above, the plurality of oxygen concentrators operates in different modes. However, according to another embodiment of the present disclosure, the plurality of oxygen concentrators may operate in the same mode (e.g., the adsorption mode or the regeneration mode).

The first air supply line 200 is provided to supply outside air to the oxygen concentration module 100.

The first air supply line 200 may have various structures capable of supplying air to the oxygen concentration module 100. The present disclosure is not restricted or limited by the structure and shape of the first air supply line 200.

More specifically, one end of the first air supply line 200 may be exposed to the atmosphere, and the other end of the first air supply line 200 may be connected to one end (e.g., a right end based on FIG. 1) of the oxygen concentration module 100.

In addition, a blower 210 (e.g., a centrifugal fan or an axial fan) may be provided in the first air supply line 200, and outside air may be sucked and forcibly transferred by a blowing force generated by the blower 210.

The heating unit 300 is provided in the first air supply line 200 and selectively heats the air, which is supplied through the first air supply line 200, by using waste heat discharged from an external heat source disposed outside the fuel cell stack 30.

In the embodiment of the present disclosure, the external heat sources disposed outside the fuel cell stack 30 may be understood as including all various external heat sources positioned outside the fuel cell stack 30 and provided in an object in which the fuel cell stack 30 is mounted. The present disclosure is not restricted or limited by the type and properties of the external heat source.

According to one embodiment of the present disclosure, the external heat source may include at least one of an engine 20 or a battery (not illustrated) provided in an object (e.g., a ship) in which the fuel cell stack 30 is mounted.

Hereinafter, the heating unit 300 provided in the first air supply line 200 is described. The heating unit 300 selectively heats the air, which is supplied through the first air supply line 200, by using waste heat discharged from the engine 20 of the object (e.g., a ship).

The heating unit 300 may have various structures capable of heating the air, which is supplied through the first air supply line 200, by using waste heat discharged from the engine 20. The present disclosure is not restricted or limited by the structure of the heating unit 300.

According to another embodiment of the present disclosure, the heating unit 300 may include: an exhaust gas guide line 310 configured to guide exhaust gas discharged from the engine 20; and a first heat exchanger 320 configured to allow the exhaust gas to exchange heat with the air supplied through the first air supply line 200.

The exhaust gas guide line 310 is configured to discharge high-temperature exhaust gas, which is discharged from the engine 20 of the ship, to the outside. The present disclosure is not restricted or limited by the structure and shape of the exhaust gas guide line 310.

The first heat exchanger 320 may have various structures capable of allowing the exhaust gas to exchange heat with the air supplied through the first air supply line 200. The present disclosure is not restricted or limited by the type and structure of the first heat exchanger 320.

For example, referring to FIG. 1, the first heat exchanger 320 may be connected to the first air supply line 200. The exhaust gas guide line 310 may pass through the first heat exchanger 320.

For example, the air (the air supplied through the first air supply line) may flow through the first heat exchanger 320. The exhaust gas may pass through the interior of the first heat exchanger 320 and be exposed to the air (the air supplied through the first air supply line) in the first heat exchanger 320.

Because the air supplied through the first air supply line 200 and the exhaust gas exchange heat with each other as described above, it is possible to increase a temperature of air to be supplied to the oxygen concentration module 100 through the first air supply line 200.

This is based on the fact that the exhaust gas discharged from the engine 20 has a high temperature. Because the first heat exchanger 320 allows the exhaust gas and the air to exchange heat with each other, it is possible to obtain an advantageous effect of reducing or minimizing the consumption of electric power required to heat the air supplied through the first air supply line 200 (e.g., minimizing an operation of a heater) and improving energy efficiency.

Among other things, in the embodiments of the present disclosure, the air may be heated by waste heat from the engine 20, such that the air supplied through the first air supply line 200 may be heated without operating a heat pump (not illustrated) and a heater (not illustrated). Therefore, it is possible to obtain an advantageous effect of improving energy efficiency.

The second air supply line 400 is configured to supply outside air to the oxygen concentration module 100 independently of the first air supply line 200. The second air supply line 400 may have various structures capable of supplying air to the oxygen concentration module 100. The present disclosure is not restricted or limited by the structure and shape of the second air supply line 400.

More specifically, one end of the second air supply line 400 may be exposed to the atmosphere, and the other end of the second air supply line 400 may be connected to the other end (e.g., a left end based on FIG. 1) of the oxygen concentration module 100.

In addition, an air compressor 410 may be provided in the second air supply line 400 and compress the air supplied through the second air supply line 400.

For reference, an inflow of air into the second air supply line 400 may be implemented by a suction force of the air compressor 410. A supply flow rate of air to be introduced into the second air supply line 400 may be determined as corresponding to the suction force of the air compressor 410.

A typical compressor capable of compressing the air supplied through the second air supply line 400 may be used as the air compressor 410. The present disclosure is not restricted or limited by the type and structure of the air compressor 410.

For example, the air compressor 410 may compress air by using a centrifugal force generated by a rotation of a rotor.

For reference, the air compressor 410 may compress air so that the air has a sufficient pressure that allows the air supplied through the second air supply line 400 to pass through an inner flow path of the fuel cell stack 30. The degree to which the air is compressed may be variously changed in accordance with the operating condition of the fuel cell stack 30.

The cooling unit 500 is provided in the second air supply line 400 and selectively cools the air, which is supplied through the second air supply line 400, by using outside cold energy applied from the outside of the fuel cell stack 30.

For reference, in the embodiment of the present disclosure, the outside cold energy applied from the outside of the fuel cell stack 30 may be understood as including all various types of outside cold energy capable of being applied from the outside of the fuel cell stack 30. The present disclosure is not restricted or limited by the type and properties of the outside cold energy.

According to the embodiment of the present disclosure, the outside cold energy may include at least one of cold energy of seawater or cold energy of the atmospheric air (low-temperature air in the atmosphere).

In one embodiment, the cooling unit 500 is provided in the second air supply line 400 and selectively cools the air, which is supplied through the second air supply line 400, by using cold energy of seawater.

According to the embodiment of the present disclosure, the air to be supplied to the oxygen concentration module 100 through the first air supply line 200 is defined as having a first pressure and a first temperature, and the air to be supplied to the oxygen concentration module 100 through the second air supply line 400 is defined as having a second pressure higher than the first pressure and having a second temperature lower than the first temperature.

The cooling unit 500 may have various structures capable of cooling the air, which is supplied through the second air supply line 400, by using the cold energy of the seawater. The present disclosure is not restricted or limited by the structure of the cooling unit 500.

According to the embodiment of the present disclosure, the cooling unit 500 may include: a seawater supply line 510 configured to supply seawater; and a second heat exchanger 520 configured to allow the seawater to exchange heat with the air supplied through the second air supply line 400.

The seawater supply line 510 may have various structures capable of supplying the seawater. The present disclosure is not restricted or limited by the structure and shape of the seawater supply line 510.

In addition, a seawater pump 512 may be provided in the seawater supply line 510. The seawater may be sucked and then forcibly transferred by pumping power generated by the seawater pump 512.

The second heat exchanger 520 may have various structures capable of allowing the seawater to exchange heat with the air supplied through the second air supply line 400. The present disclosure is not restricted or limited by the type and structure of the second heat exchanger 520.

For example, referring to FIG. 1, the second heat exchanger 520 may be connected to the second air supply line 400. The seawater supply line 510 may pass through the second heat exchanger 520.

For example, the air (the air supplied through the second air supply line) may flow through the second heat exchanger 520. The seawater may pass through the interior of the second heat exchanger 520 and be exposed to the air (the air supplied through the second air supply line) in the second heat exchanger 520.

Because the air supplied through the second air supply line 400 and the seawater exchange heat with each other as described above, it is possible to decrease a temperature of air to be supplied to the oxygen concentration module 100 through the second air supply line 400.

This is based on the fact that the seawater has a low temperature. Because the second heat exchanger 520 allows the seawater and the air to exchange heat with each other, it is possible to obtain an advantageous effect of minimizing the consumption of electric power required to cool the air supplied through the second air supply line 400 (e.g., minimizing an operation of a heat pump) and improving energy efficiency.

Among other things, in the embodiment of the present disclosure, the air may be cooled by the cold energy of the seawater, such that the air supplied through the second air supply line 400 may be cooled without operating a heat pump (not illustrated) and a cooling means (not illustrated). Therefore, it is possible to obtain an advantageous effect of improving energy efficiency.

The stack connection line 600 is configured to supply oxygen-enriched air, which is produced in the oxygen concentration module 100, to the fuel cell stack 30.

The stack connection line 600 may have various structures capable of connecting the oxygen concentration module 100 and the fuel cell stack 30. The present disclosure is not restricted or limited by the structure and shape of the stack connection line 600.

According to the embodiment of the present disclosure, the fuel cell system 10 may include a buffer tank 610 provided in the stack connection line 600 and configured to temporarily store the oxygen-enriched air.

A typical storage tank capable of storing the oxygen-enriched air may be used as the buffer tank 610. The present disclosure is not restricted or limited by the structure and shape of the buffer tank 610.

Because the buffer tank 610 is provided in the stack connection line 600 as described above, it is possible to obtain an advantageous effect of minimizing changes in supply pressure and flow rate of the oxygen-enriched air caused by pulsation or hunting. Further, it is possible to obtain an advantageous effect of constantly maintaining the supply pressure and flow rate of the oxygen-enriched air to be supplied to the fuel cell stack 30.

In addition, according to the embodiment of the present disclosure, the fuel cell system 10 may include a flow rate adjusting unit 620 provided in the stack connection line 600 and configured to adjust a supply flow rate of the oxygen-enriched air.

Various flow rate adjusting devices capable of adjusting the supply flow rate of the oxygen-enriched air supplied through the stack connection line 600 may be used as the flow rate adjusting unit 620. The present disclosure is not restricted or limited by the type and structure of the flow rate adjusting unit 620.

For example, a typical flow rate adjusting valve may be used as the flow rate adjusting unit 620.

Because the flow rate adjusting unit 620 is provided in the stack connection line 600 as described above, it is possible to obtain an advantageous effect of optimizing the supply flow rate of the oxygen-enriched air to be supplied to the fuel cell stack 30 in accordance with the operating condition of the fuel cell stack 30.

Meanwhile, the connection structure between the oxygen concentration module 100 (e.g., the first oxygen concentrator and the second oxygen concentrator) and the first and second air supply lines 200 and 400 may be variously changed in accordance with required conditions and design specifications. The present disclosure is not restricted or limited by the connection structure between the oxygen concentration module 100 and the first and second air supply lines 200 and 400.

According to another embodiment of the present disclosure, the fuel cell system 10 may include: a first-first connection line 112 configured to connect the first air supply line 200 and the first oxygen concentrator 110 and connected to the stack connection line 600. The fuel cell system 10 may further include: a first-second connection line 122 configured to connect the first air supply line 200 and the second oxygen concentrator 120 and connected to the stack connection line 600; a second-first connection line 116 configured to connect the second air supply line 400 and the first oxygen concentrator 110; and a second-second connection line 126 configured to connect the second air supply line 400 and the second oxygen concentrator 120. The the fuel cell system 10 may further include: a first exhaust line 117 connected to the second-first connection line 116; a second exhaust line 127 connected to the second-second connection line 126; a first valve 114 configured to selectively open or close the first-first connection line 112 and connected to the stack connection line 600; a second valve 124 configured to selectively open or close the first-second connection line 122 and connected to the stack connection line 600; a third valve 118 configured to selectively open or close the second-first connection line 116 and connected to the first exhaust line 117; and a fourth valve 128 configured to selectively open or close the second-second connection line 126 and connected to the second exhaust line 127.

The first-first connection line 112 is configured to connect the first air supply line 200 and the first oxygen concentrator 110, and the first-second connection line 122 is configured to connect the first air supply line 200 and the second oxygen concentrator 120.

For example, when the first oxygen concentrator 110 or the second oxygen concentrator 120 operates in the regeneration mode (the mode for desorbing nitrogen from the adsorbent), the air (high-temperature, low-pressure air) supplied through the first air supply line 200 may be supplied to the first oxygen concentrator 110 through the first-first connection line 112 or supplied to the first oxygen concentrator 110 through the first-second connection line 122.

The first valve 114 connects the first-first connection line 112 and the stack connection line 600 and selectively opens or closes the first-first connection line 112.

A typical valve means capable of selectively opening or closing the first-first connection line 112 may be used as the first valve 114. The present disclosure is not restricted or limited by the type and structure of the first valve 114.

For example, a typical three-way valve may be used as the first valve 114. The first valve 114 may selectively block (cut off) a flow of the air to be supplied to the first oxygen concentrator 110 from the first-first connection line 112 or selectively block (cut off) a flow of the oxygen-enriched air to be supplied to the stack connection line 600 from the first oxygen concentrator 110.

The second valve 124 connects the first-second connection line 122 and the stack connection line 600 and selectively opens or closes the first-second connection line 122.

A typical valve means capable of selectively opening or closing the first-second connection line 122 may be used as the second valve 124. The present disclosure is not restricted or limited by the type and structure of the second valve 124.

For example, a typical three-way valve may be used as the second valve 124. The second valve 124 may selectively block (cut off) a flow of the air to be supplied to the second oxygen concentrator 120 from the first-second connection line 122 or selectively block (cut off) a flow of the oxygen-enriched air to be supplied to the stack connection line 600 from the second oxygen concentrator 120.

The second-first connection line 116 is configured to connect the second air supply line 400 and the first oxygen concentrator 110, and the second-second connection line 126 is configured to connect the second air supply line 400 and the second oxygen concentrator 120.

For example, when the first oxygen concentrator 110 or the second oxygen concentrator 120 operates in the adsorption mode (the mode for adsorbing nitrogen to the adsorbent), the air (low-temperature, high-pressure air) supplied through the second air supply line 400 may be supplied to the first oxygen concentrator 110 through the second-first connection line 116 or supplied to the second oxygen concentrator 120 through the second-second connection line 126.

The first exhaust line 117 is connected to the second-first connection line 116 and guides nitrogen air discharged from the first oxygen concentrator 110 (air containing nitrogen desorbed from the adsorbent). The second exhaust line 127 is connected to the second-first connection line 116 and guides nitrogen air discharged from the second oxygen concentrator 120 (air containing nitrogen desorbed from the adsorbent).

For example, when the first oxygen concentrator 110 or the second oxygen concentrator 120 operates in the regeneration mode (the mode for desorbing nitrogen from the adsorbent), the nitrogen air discharged from the first oxygen concentrator 110 may be discharged to the outside through the first exhaust line 117, and the nitrogen air discharged from the second oxygen concentrator 120 may be discharged to the outside through the second exhaust line 127.

The third valve 118 connects the second-first connection line 116 and the first exhaust line 117 and selectively opens or closes the second-first connection line 116.

A typical valve means capable of selectively opening or closing the second-first connection line 116 may be used as the third valve 118. The present disclosure is not restricted or limited by the type and structure of the third valve 118.

For example, a typical three-way valve may be used as the third valve 118. The third valve 118 may selectively block (cut off) a flow of the air to be supplied to the first oxygen concentrator 110 from the second-first connection line 116 or selectively block (cut off) a flow of the nitrogen air to be discharged to the first exhaust line 117 from the first oxygen concentrator 110.

The fourth valve 128 connects the second-second connection line 126 and the second exhaust line 127 and selectively opens or closes the second-second connection line 126.

A typical valve means capable of selectively opening or closing the second-second connection line 126 may be used as the fourth valve 128. The present disclosure is not restricted or limited by the type and structure of the fourth valve 128.

For example, a typical three-way valve may be used as the fourth valve 128. The fourth valve 128 may selectively block (cut off) a flow of the air to be supplied to the second oxygen concentrator 120 from the second-second connection line 126 or selectively block (cut off) a flow of the nitrogen air to be discharged to the second exhaust line 127 from the second oxygen concentrator 120.

In one embodiment of the present disclosure, the fuel cell system 10 may include: an exhaust connection line 160 connected to the first air supply line 200 and configured to connect the first exhaust line 117 and the second exhaust line 127 in parallel; and an exhaust valve 162 configured to selectively open or close the exhaust connection line 160.

The exhaust connection line 160 may have various structures capable of connecting the first exhaust line 117 and the second exhaust line 127 in parallel. The present disclosure is not restricted or limited by the structure and shape of the exhaust connection line 160.

Therefore, the nitrogen air, which is discharged from the first oxygen concentrator 110 to the first exhaust line 117, and the nitrogen air, which is discharged from the second oxygen concentrator 120 to the second exhaust line 127, may be discharged to the outside after passing through the exhaust connection line 160 in common.

Because the nitrogen air discharged through the first and second exhaust lines 117 and 127 is discharged through the exhaust connection line 160 as described above, it is possible to obtain an advantageous effect of reducing or minimizing the structures and sizes of the first and second exhaust lines 117 and 127 and improving the spatial utilization and the degree of design freedom.

In addition, when the exhaust connection line 160 is connected to the first air supply line 200, the air supplied through the first air supply line 200 may be discharged directly to the outside through the exhaust connection line 160 without passing through the oxygen concentration module 100 (e.g., the first oxygen concentrator and the second oxygen concentrator).

The exhaust valve 162 is configured to selectively open or close the exhaust connection line 160.

A typical valve means capable of selectively opening or closing the exhaust connection line 160 may be used as the exhaust valve 162. The present disclosure is not restricted or limited by the type and structure of the exhaust valve 162. For example, a typical solenoid valve may be used as the exhaust valve 162.

In the embodiment of the present disclosure illustrated and described above, the example has been described in which an outlet end of the first exhaust line 117 and an outlet end of the second exhaust line 127 are connected to the exhaust connection line 160. However, according to another embodiment of the present disclosure, the outlet end of the first exhaust line and the outlet end of the second exhaust line may be exposed directly to the outside without a separate exhaust connection line.

According to the embodiment of the present disclosure, the fuel cell system 10 may include: a bypass line 170 configured to connect the second air supply line 400 and the stack connection line 600 and allow the air to flow from the second air supply line 400 to the stack connection line 600; and a bypass valve 172 configured to selectively open or close the bypass line 170.

More specifically, one end of the bypass line 170 may be connected to the second air supply line 400, and the other end of the bypass line 170 may be connected to the stack connection line 600. The bypass line 170 may allow the air supplied through the second air supply line 400 to be supplied directly to the stack connection line 600 through the bypass line 170 without passing through the oxygen concentration module 100 (e.g., the first oxygen concentrator and the second oxygen concentrator).

The bypass line 170 may have various structures capable of connecting the second air supply line 400 and the stack connection line 600. The present disclosure is not restricted or limited by the structure and shape of the bypass line 170.

The bypass valve 172 is configured to selectively open or close the bypass line 170.

A typical valve means capable of selectively opening or closing the bypass line 170 may be used as the bypass valve 172. The present disclosure is not restricted or limited by the type and structure of the bypass valve 172. For example, a typical solenoid valve may be used as the bypass valve 172.

As described above, in the embodiment of the present disclosure, the bypass line 170 configured to connect the second air supply line 400 and the stack connection line 600 is provided. Therefore, when a target oxygen concentration of the oxygen-enriched air produced by the oxygen concentration module 100 is lower than an atmospheric oxygen concentration (an oxygen concentration of air in the atmosphere), the air supplied through the second air supply line 400 (the air having a sufficient oxygen concentration) may flow directly to the stack connection line 600 without passing through the oxygen concentration module 100.

In contrast, when the target oxygen concentration of the oxygen-enriched air is higher than the atmospheric oxygen concentration, the bypass line 170 may be closed by the bypass valve 172, and the air supplied through the second air supply line 400 may be converted into the oxygen-enriched air while passing through the oxygen concentration module 100 and then supplied to the stack connection line 600.

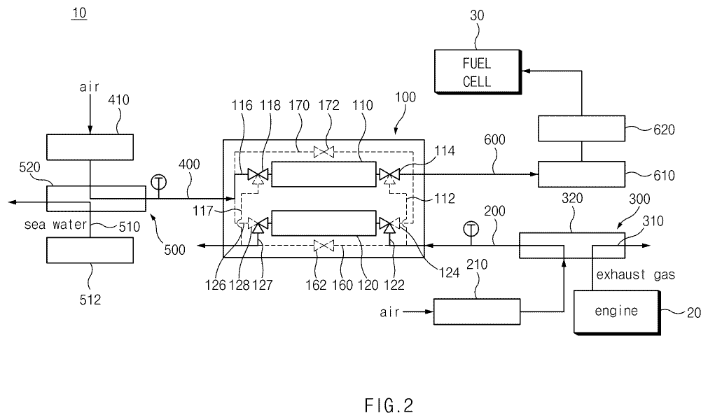

Hereinafter, an operational structure of the fuel cell system 10 according to the embodiment of the present disclosure will be described with reference to FIGS. 2 to 5.

According to one embodiment of the present disclosure, the first oxygen concentrator 110 and the second oxygen concentrator 120 may alternately perform the adsorption mode and the regeneration mode.

In this case, the adsorption mode may be defined as a mode for adsorbing nitrogen contained in the air to the adsorbent 102. The regeneration mode may be defined as a mode for desorbing (separating) the nitrogen, which is adsorbed to the adsorbent 102, from the adsorbent 102.

Referring to FIG. 2, when the first oxygen concentrator 110 performs the adsorption mode, the air supplied through the second air supply line 400 may exchange heat with (be cooled by) the seawater through the second heat exchanger 520 and then be supplied to the first oxygen concentrator 110.

Because the air supplied to the first oxygen concentrator 110 via the second heat exchanger 520 has the low-temperature, high-pressure property, nitrogen contained in the air (low-temperature, high-pressure air) may be adsorbed to the adsorbent 102, and the oxygen-enriched air having a high-purity oxygen concentration may be discharged from the first oxygen concentrator 110 and then supplied to the buffer tank 610 through the stack connection line 600 (or supplied to the fuel cell stack via the buffer tank).

When the first oxygen concentrator 110 performs the adsorption mode, the second oxygen concentrator 120 performs the regeneration mode.

When the second oxygen concentrator 120 performs the regeneration mode, the second-second connection line 126 may be closed by the fourth valve 128, and the air supplied through the first air supply line 200 may exchange heat with (be heated by) the exhaust gas through the first heat exchanger 320 and then be supplied to the second oxygen concentrator 120.

Because the air supplied to the second oxygen concentrator 120 via the first heat exchanger 320 has the high-temperature, low-pressure property, the nitrogen adsorbed to the adsorbent 102 may be desorbed (separated) from the adsorbent 102, and the nitrogen air containing nitrogen may be discharged from the second oxygen concentrator 120 and then discharged to the outside through the second exhaust line 127 and the exhaust connection line.

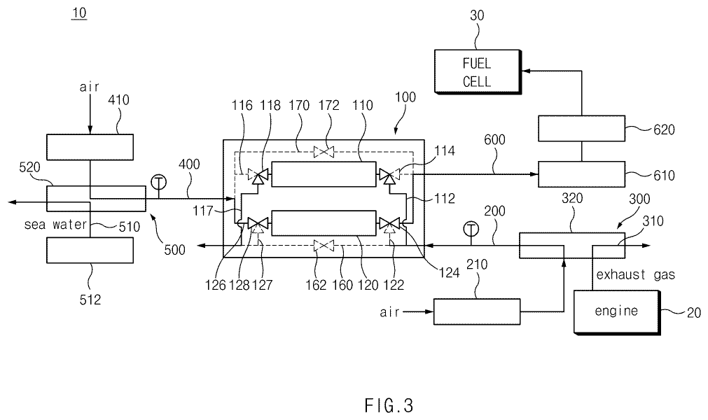

Referring to FIG. 3, because nitrogen adsorption efficiency of the adsorbent 102 deteriorates after the first oxygen concentrator 110 performs the adsorption mode for a predetermined time, the mode of the first oxygen concentrator 110 is switched to the regeneration mode.

When the first oxygen concentrator 110 performs the regeneration mode, the second-first connection line 116 may be closed by the third valve 118, and the air supplied through the first air supply line 200 may exchange heat with (be heated by) the exhaust gas through the first heat exchanger 320 and then be supplied to the first oxygen concentrator 110.

Because the air supplied to the first oxygen concentrator 110 via the first heat exchanger 320 has the high-temperature, low-pressure property, the nitrogen adsorbed to the adsorbent 102 may be desorbed (separated) from the adsorbent 102, and the nitrogen air containing nitrogen may be discharged from the first oxygen concentrator 110 and then discharged to the outside through the first exhaust line 117 and the exhaust connection line.

When the first oxygen concentrator 110 performs the regeneration mode, the second oxygen concentrator 120 performs the adsorption mode.

When the second oxygen concentrator 120 performs the adsorption mode, the air supplied through the second air supply line 400 may exchange heat with (be cooled by) the seawater through the second heat exchanger 520 and then be supplied to the second oxygen concentrator 120.

Because the air supplied to the second oxygen concentrator 120 via the second heat exchanger 520 has the low-temperature, high-pressure property, nitrogen contained in the air (low-temperature, high-pressure air) may be adsorbed to the adsorbent 102, and the oxygen-enriched air having a high-purity oxygen concentration may be discharged from the second oxygen concentrator 120 and then supplied to the buffer tank 610 through the stack connection line 600 (supplied to the fuel cell stack via the buffer tank).

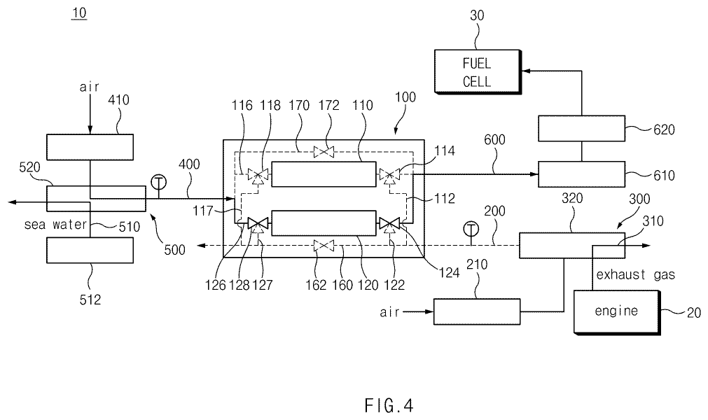

Meanwhile, referring to FIG. 4, when the time required for the regeneration mode of the first oxygen concentrator 110 (or the second oxygen concentrator) is shorter than the time required for the adsorption mode of the second oxygen concentrator 120 (or the first oxygen concentrator), the mode of the first oxygen concentrator 110 may be switched to the rest mode.

In this case, the rest mode refers to a mode in which both the inflow of the low-temperature, high-pressure air and the inflow of the high-temperature, low-pressure air are cut off. The first-first connection line 112 may be closed by the first valve 114, and the second-first connection line 116 may be closed by the third valve 118.

According to another embodiment of the present disclosure, a particular oxygen concentrator may perform the rest mode even in a case in which the number of oxygen concentrators constituting the oxygen concentration module is sufficiently large and a predetermined time remains until the adsorption mode is performed after the particular oxygen concentrator completes the regeneration mode.

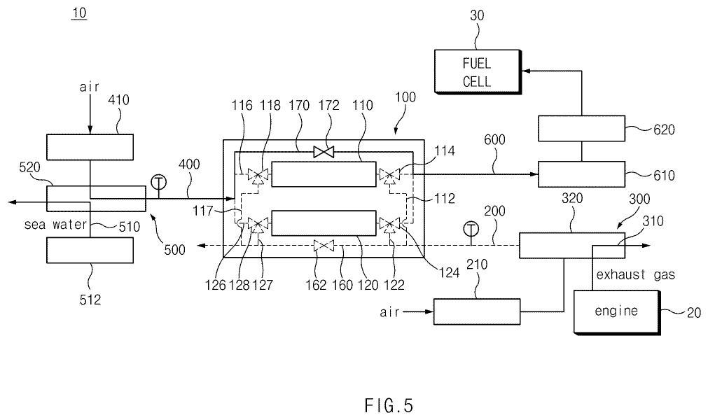

In addition, referring to FIG. 5, when the target oxygen concentration of the oxygen-enriched air produced by the oxygen concentration module 100 is lower than the atmospheric oxygen concentration (an oxygen concentration of air in the atmosphere), the air supplied through the second air supply line 400 (the air having a sufficient oxygen concentration) may flow directly to the stack connection line 600 without passing through the oxygen concentration module 100.

When the oxygen concentration module 100 performs the bypass mode, the bypass line 170 may be opened, but the first-first connection line 112 may be closed by the first valve 114, the first-second connection line 122 may be closed by the second valve 124, the second-first connection line 116 may be closed by the third valve 118, and the second-second connection line 126 may be closed by the fourth valve 128.

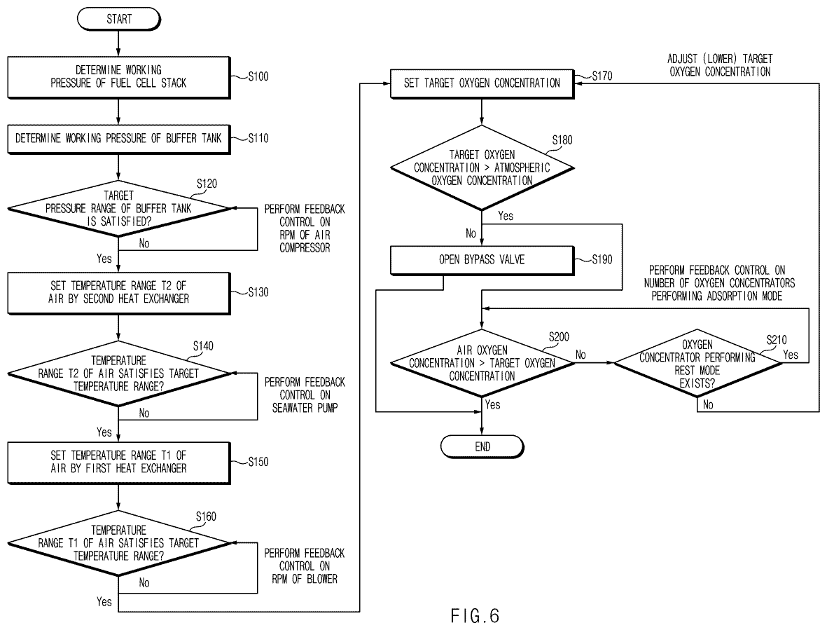

Meanwhile, FIG. 6 is a flowchart for explaining a method of controlling the fuel cell system 10 according to the embodiment of the present disclosure. Further, the parts identical and equivalent to the parts in the above-mentioned configuration will be designated by the identical or equivalent reference numerals, and detailed descriptions thereof will be omitted.

The method of controlling the fuel cell system 10 according to one embodiment of the present disclosure may include: step S100 of determining a working pressure of the fuel cell stack 30; step S110 of determining a working pressure of the buffer tank 610; and step S120 of determining whether a pressure of the buffer tank 610 satisfies a target pressure. The method further includes: step S130 of setting a temperature range T2 of air by the second heat exchanger 520 when the pressure of the buffer tank 610 satisfies the target pressure; step S140 of determining whether the temperature range T2 of air by the second heat exchanger 520 satisfies a target temperature range; and step S150 of setting a temperature range T1 of air by the first heat exchanger 320. The method further includes: step S160 of determining whether the temperature range T1 of air by the first heat exchanger 320 satisfies the target temperature range; step S170 of setting a target oxygen concentration of air to be supplied to the fuel cell stack 30 when the temperature range T1 of air by the first heat exchanger 320 satisfies the target temperature range; and step S180 of determining whether the set target oxygen concentration is higher than an atmospheric oxygen concentration. The method further includes: step S190 of opening the bypass valve when the target oxygen concentration is higher than the atmospheric oxygen concentration; step S200 of determining whether an oxygen concentration of air to be supplied to the fuel cell stack 30 is higher than the target oxygen concentration when the target oxygen concentration is lower than the atmospheric oxygen concentration; and step S210 of checking whether the oxygen concentrator, which performs the rest mode, exists when the oxygen concentration of the air to be supplied to the fuel cell stack 30 is lower than the target oxygen concentration.

First, when the working pressure of the fuel cell stack 30 and the working pressure of the buffer tank 610 are determined, whether the pressure of the buffer tank 610 satisfies the target pressure is determined.

Next, when the pressure of the buffer tank 610 satisfies the target pressure, the temperature range T2 of the air (low-temperature, high-pressure air) by the second heat exchanger 520 is set.

In contrast, when the pressure of the buffer tank 610 does not satisfy the target pressure (e.g., the pressure of the buffer tank is lower than the target pressure), the pressure of the buffer tank 610 may be adjusted by performing feedback control on the revolutions per minute (RPM) of the air compressor 410 (the revolutions per minute of the rotor of the air compressor).

Next, whether the temperature range T2 of the air by the second heat exchanger 520 satisfies the target temperature range is determined. When the temperature range T2 of the air by the second heat exchanger 520 satisfies the target temperature range, the temperature range T1 of the air by the first heat exchanger 320 is set.

In contrast, when the temperature range T2 of the air by the second heat exchanger 520 does not satisfy the target temperature range (e.g., the temperature range of the air by the second heat exchanger is lower than the target temperature range), the temperature range T2 of the air by the second heat exchanger 520 may be adjusted by performing feedback control on the revolutions per minute of the seawater pump 512.

Next, whether the temperature range T1 of the air by the first heat exchanger 320 satisfies the target temperature range is determined. When the temperature range T1 of the air by the first heat exchanger 320 satisfies the target temperature range, the target oxygen concentration of the air to be supplied to the fuel cell stack 30 is set.

In contrast, when the temperature range T1 of the air by the first heat exchanger 320 does not satisfy the target temperature range (e.g., the temperature range T1 of the air by the first heat exchanger is lower than the target temperature range), the temperature range T1 of the air by the first heat exchanger 320 may be adjusted by performing feedback control on the revolutions per minute (RPM) of the blower 210 (revolutions per minute of a fan of the blower).

Next, whether the set target oxygen concentration is higher than the atmospheric oxygen concentration is determined. When the target oxygen concentration is higher than the atmospheric oxygen concentration, the bypass valve is opened. When the bypass valve is opened, the air supplied through the second air supply line 400 may flow to the stack connection line 600 through the bypass line 170 without passing through the oxygen concentration module 100.

In contrast, when the target oxygen concentration is lower than the atmospheric oxygen concentration, whether the oxygen concentration of the air to be supplied to the fuel cell stack 30 is higher than the target oxygen concentration is determined.

When the oxygen concentration of the air to be supplied to the fuel cell stack is higher than the target oxygen concentration, the supply of the air (the low-temperature, high-pressure air and the high-temperature, low-pressure air) to the oxygen concentration module 100 may be cut off.

In contrast, when the oxygen concentration of the air to be supplied to the fuel cell stack 30 is lower than the target oxygen concentration, whether the oxygen concentrator, which performs the rest mode, exists is checked.

When the oxygen concentrator, which performs the rest mode, exists in the condition in which the oxygen concentration of the air to be supplied to the fuel cell stack is lower than the target oxygen concentration, the oxygen concentration of the air to be supplied to the fuel cell stack 30 may be adjusted by performing feedback control on the number of oxygen concentrators that perform the adsorption mode.

In contrast, when the oxygen concentrator, which performs the rest mode, does not exist in the condition in which the oxygen concentration of the air to be supplied to the fuel cell stack 30 is lower than the target oxygen concentration, the target oxygen concentration of the air to be supplied to the fuel cell stack 30 may be adjusted (e.g., lowered).

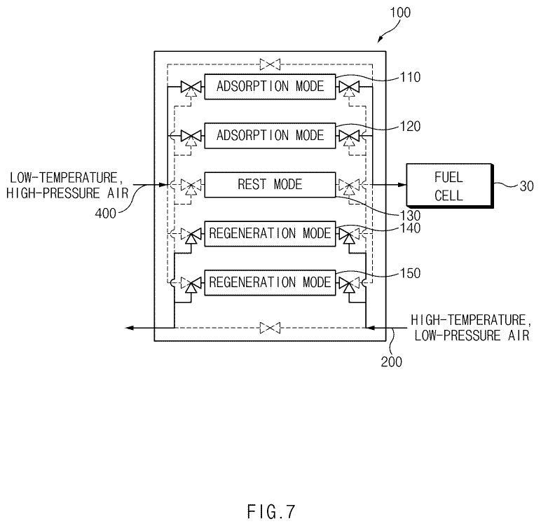

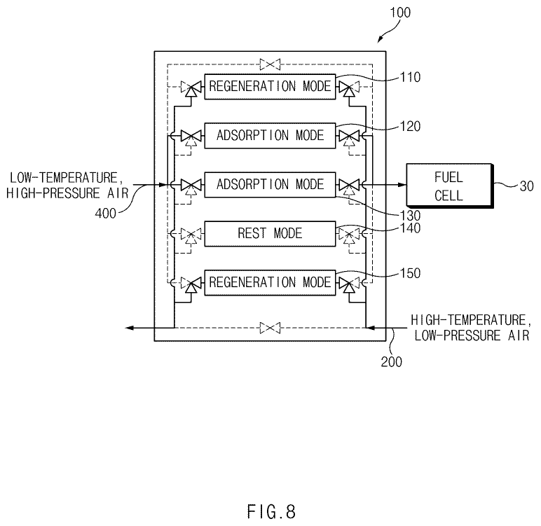

Meanwhile, FIGS. 7 and 8 are views illustrating a modified example of the fuel cell system 10 according to the present disclosure.

Referring to FIGS. 7 and 8, the oxygen concentration module 100 of the fuel cell system 10 includes a plurality of oxygen concentrators connected in parallel to the first air supply line 200 and the second air supply line 400. When some of the plurality of oxygen concentrators perform the adsorption mode, the other oxygen concentrators may perform the regeneration mode or the rest mode.

In one embodiment, the oxygen concentration module 100 includes a first oxygen concentrator 110, a second oxygen concentrator 120, a third oxygen concentrator 130, a fourth oxygen concentrator 140, and a fifth oxygen concentrator 150 that independently produce oxygen-enriched air.

According to the embodiment of the present disclosure, to satisfy the target oxygen concentration, when two oxygen concentrators, among the five oxygen concentrators, perform the adsorption mode, two other oxygen concentrators, among the five oxygen concentrators, may perform the regeneration mode, and the other oxygen concentrator, among the five oxygen concentrators, may perform the rest mode.

In addition, the time for which the five oxygen concentrators perform the adsorption mode, the regeneration mode, and the rest mode may be variously changed in accordance with required conditions and design specifications. For example, the five oxygen concentrators (e.g., the first to fifth oxygen concentrators) may perform the adsorption mode and the regeneration mode for 2 minutes and perform the rest mode for 1 minute.

Referring to FIG. 7, when the first and second oxygen concentrators 110 and 120 perform the adsorption mode, the third oxygen concentrator 130 may perform the rest mode, and the fourth and fifth oxygen concentrators 140 and 150 may perform the regeneration mode.

Thereafter, when a predetermined time (e.g., 3 minutes) has elapsed, as illustrated in FIG. 8, the mode of the second and third oxygen concentrator 120 and 130 may be switched to the adsorption mode, the mode of the fourth oxygen concentrator 140 may be switched to the rest mode, and the fifth and first oxygen concentrators 150 and 110 may be switched to the regeneration mode.

In this way, the five oxygen concentrators (e.g., the first to fifth oxygen concentrators) may alternately and repeatedly perform the adsorption mode, the regeneration mode, and the rest mode.

According to the embodiment of the present disclosure described above, it is possible to obtain an advantageous effect of improving the output and system efficiency of the fuel cell system.

In particular, according to the embodiment of the present disclosure, it is possible to obtain an advantageous effect of reducing or minimizing the consumption of energy (parasitic electric power) required for the process of concentrating oxygen and improving the output and efficiency of the fuel cell system.

Among other things, according to the embodiment of the present disclosure, it is possible to perform the pressure-temperature swing adsorption process of improving the purity of oxygen by using cold energy of seawater and waste heat (exhaust gas) generated by the engine of the ship.

In addition, according to the embodiment of the present disclosure, it is possible to obtain an advantageous effect of increasing the amount of oxygen to be treated and efficiency in concentrating oxygen and minimizing the amount of time required for the process of concentrating oxygen.

In addition, according to the embodiment of the present disclosure, it is possible to obtain an advantageous effect of minimizing the deterioration in performance caused by degradation of the fuel cell stack.

While the embodiments have been described above, the embodiments are just illustrative and not intended to limit the present disclosure. It can be appreciated by those having ordinary skill in the art that various modifications and applications, which are not described above, may be made to the present embodiment without departing from the intrinsic features of the present disclosure. For example, the respective constituent elements specifically described in the embodiments may be modified and then carried out. Further, it should be interpreted that the differences related to the modifications and applications are included in the scope of the present disclosure.

What is claimed is:

1. A fuel cell system comprising:
an oxygen concentration module configured to produce oxygen-enriched air by separating nitrogen from air;
a first air supply line connected to the oxygen concentration module and configured to supply air to the oxygen concentration module;
a heating unit provided in the first air supply line and configured to selectively heat air, which is supplied through the first air supply line, by using waste heat discharged from an external heat source provided outside a fuel cell stack;
a second air supply line connected to the oxygen concentration module and configured to supply air to the oxygen concentration module independently of the first air supply line;
a cooling unit provided in the second air supply line and configured to selectively cool air, which is supplied through the second air supply line, by using outside cold energy applied from an outside of the fuel cell stack; and
a stack connection line configured to connect the oxygen concentration module and the fuel cell stack and configured to supply the oxygen-enriched air to the fuel cell stack.

2. The fuel cell system of claim 1, wherein the external heat source comprises at least one of an engine or a battery provided in an object in which the fuel cell stack is mounted.

3. The fuel cell system of claim 2, wherein the heating unit comprises:
an exhaust gas guide line configured to guide exhaust gas discharged from the engine; and
a first heat exchanger configured to allow the exhaust gas to exchange heat with the air supplied through the first air supply line.

4. The fuel cell system of claim 1, wherein the outside cold energy comprises at least one of cold energy of seawater or cold energy of atmospheric air.

5. The fuel cell system of claim 4, wherein the cooling unit comprises:
a seawater supply line configured to supply the seawater; and
a second heat exchanger configured to allow the seawater to exchange heat with the air supplied through the second air supply line.

6. The fuel cell system of claim 1, wherein the oxygen concentration module comprises a plurality of oxygen concentrators connected in parallel to the first and second air supply lines and configured to accommodate adsorbents that selectively adsorb and desorb the nitrogen based on a temperature and pressure of the air.

7. The fuel cell system of claim 6, wherein when first oxygen concentrators of the plurality of oxygen concentrators perform an adsorption mode for adsorbing the nitrogen to the adsorbent, second oxygen concentrators of the plurality of oxygen concentrators perform a regeneration mode for desorbing the nitrogen from the adsorbent or perform a rest mode for cutting off an inflow of the air.

8. The fuel cell system of claim 1, wherein the oxygen concentration module comprises:
a first oxygen concentrator connected to the first air supply line and the second air supply line and configured to selectively produce the oxygen-enriched air; and
a second oxygen concentrator connected to the first air supply line and the second air supply line and configured to selectively produce the oxygen-enriched air independently of the first oxygen concentrator.

9. The fuel cell system of claim 8, wherein the first and second oxygen concentrators alternately produce the oxygen-enriched air, and the stack connection line continuously supplies the oxygen-enriched air.

10. The fuel cell system of claim 8, comprising:
a first-first connection line configured to connect the first air supply line and the first oxygen concentrator and connected to the stack connection line;
a first-second connection line configured to connect the first air supply line and the second oxygen concentrator and connected to the stack connection line;
a second-first connection line configured to connect the second air supply line and the first oxygen concentrator;
a second-second connection line configured to connect the second air supply line and the second oxygen concentrator;
a first exhaust line connected to the second-first connection line;
a second exhaust line connected to the second-second connection line;
a first valve configured to selectively open or close the first-first connection line and connected to the stack connection line;
a second valve configured to selectively open or close the first-second connection line and connected to the stack connection line;
a third valve configured to selectively open or close the second-first connection line and connected to the first exhaust line; and
a fourth valve configured to selectively open or close the second-second connection line and connected to the second exhaust line.

11. The fuel cell system of claim 10, comprising:
an exhaust connection line connected to the first air supply line and configured to connect the first exhaust line and the second exhaust line in parallel; and
an exhaust valve configured to selectively open or close the exhaust connection line.

12. The fuel cell system of claim 1, comprising:
a bypass line configured to connect the second air supply line and the stack connection line and configured to allow the air to flow from the second air supply line to the stack connection line; and
a bypass valve configured to selectively open or close the bypass line.

13. The fuel cell system of claim 1, comprising:
a buffer tank provided in the stack connection line and configured to temporarily store the oxygen-enriched air.

14. The fuel cell system of claim 1, comprising:
a flow rate adjusting unit provided in the stack connection line and configured to adjust a supply flow rate of the oxygen-enriched air.

15. The fuel cell system of claim 1, wherein the air supplied to the oxygen concentration module through the first air supply line has a first pressure and a first temperature, and the air supplied to the oxygen concentration module through the second air supply line has a second pressure and a second temperature, wherein the second pressure is higher than the first pressure and the second temperature is lower than the first temperature.
